(19) United States
(12) Patent Application Publication
(10) Pub. No.: US 2017/0045976 A1
(43) Pub. Date: Feb. 16, 2017

(54) Electronic Devices With Shear Force Sensing

(71) Applicant: Apple Inc., Cupertino, CA (US)

(72) Inventors: Tyler S. Bushnell, Mountain View, CA (US); William C. Lukens, San Francisco, CA (US); Collin R. Petty, San Francisco, CA (US)

(21) Appl. No.: 14/822,327

(22) Filed: Aug. 10, 2015

(51) Int. Cl. G06F 3/041; G06F 3/044; H01H 13/14

(52) U.S. Cl. CPC G06F 3/0414; H01H 13/14; G06F 3/044; H01H 2205/002

(57) ABSTRACT

An electronic device may be provided with a display, trackpad member, or other structure that can shift laterally with respect to another device structure in response to the application of shear force. Shear force may be applied by the fingers of a user. Shear force sensors may be provided in an electronic device to measure the shear force that is applied. The shear force sensors may be capacitive sensors. A capacitive shear force sensor may have capacitive electrodes. In response to application of shear force, the capacitive electrodes may move with respect to each other. Parallel planar electrodes may shift with respect to each other so that the amount of overlap and therefore capacitance between the electrodes changes or the separation distance between parallel planar electrodes may increase or decrease to produce measureable capacitance changes.

### BACKGROUND

This relates generally to electronic devices, and, more particularly, to sensors in electronic devices.

Electronic devices such as cellular telephones, computers, and wristwatch devices include input devices through which a user can supply input to control device operation. For example, an electronic device may include buttons with which a user can supply input. Touch sensors may be incorporated into displays, trackpads, and other portions of devices to track the location and motion of a user's fingers. Using touch sensor technology, a user may interact with on-screen content or may control the position of a cursor.

Some devices incorporate force sensors. For example, a track pad or wristwatch device may include force sensors to detect when a user is pressing downwards on the trackpad or a display in the wristwatch. Force input of this type may be used in conjunction with touch sensor input to control the operation of an electronic device.

There are challenges associated with using input devices such as touch and force sensors in electronic devices. Touch sensor gestures involve movement of a user's fingers across a device surface. This type of arrangement may be awkward in scenarios in which there is insufficient surface area to accommodate finger movement. Touch sensors such as capacitive touch sensors may be susceptible to interference from moisture, because moisture may cause changes in capacitance even in the absence of a user's finger. Force-sensor buttons are generally used only to gather information on how strongly a user is pressing inwardly.

It would therefore be desirable to be able to provide improved sensors for electronic devices.

### SUMMARY

An electronic device may be provided with a display, trackpad member, or other structure that can shift laterally with respect to another device structure in response to the application of shear force. Shear force may be applied by the fingers of a user. For example, a user can impart lateral force on the surface of a display while a game or other content is being displayed on the display. Shear force sensors may be provided in an electronic device to measure the shear force that is applied.

The shear force sensors may be capacitive sensors. A capacitive shear force sensor may have capacitive electrodes. In response to application of shear force, the capacitive electrodes may move with respect to each other. Capacitive shear force sensors may have planar electrodes that are parallel to each other. The planar electrodes may be mounted to an elastomeric support that deforms under applied force and/or may be coupled to structures such as displays, touch sensors, housing structures, and other device structures that move with respect to each other.

Parallel planar electrodes in a shear sensor may shift with respect to each other so that the amount of overlap and therefore the amount of capacitance between the electrodes changes. In some configurations, a separation distance between parallel planar electrodes may increase or decrease in response to the application of shear force.

Shear force sensors may be used in devices such as keyboards, joysticks, accessory controllers, and other equipment. The shear force sensors may be used to measure lateral shifts in the position of device components, twisting forces applied to the outer surfaces of cylindrical devices, and other applied shear forces.

Further features of the invention, its nature and various advantages will be more apparent from the accompanying drawings and the following detailed description of the preferred embodiments.

### BRIEF DESCRIPTION OF THE DRAWINGS

FIG. 1 is a perspective view of an illustrative electronic device that may include sensors in accordance with an embodiment.

FIG. 2 is a perspective view of an illustrative electronic device such as a laptop computer that may include sensors in accordance with an embodiment.

FIG. 3 is a schematic diagram of an illustrative electronic device that may sensors in accordance with an embodiment.

FIG. 4 is a cross-sectional side view of an illustrative shear force sensor in an undeflected configuration in accordance with an embodiment.

FIG. 5 is a cross-sectional side view of an illustrative shear force sensor in a deflected configuration in accordance with an embodiment.

FIG. 6 is a cross-sectional side view of an illustrative electronic device with force sensors in accordance with an embodiment.

FIG. 7 is a top view of an illustrative electronic device surface showing potential locations for shear force sensors in accordance with an embodiment.

FIG. 8 is a perspective view of an illustrative electronic device with shear force sensors being controlled by a user in accordance with an embodiment.

FIG. 9 is a cross-sectional side view of an illustrative shear force sensor with an ancillary electrode in accordance with an embodiment.

FIG. 10 is a cross-sectional side view of an illustrative shear force sensor with multiple ancillary electrodes in accordance with an embodiment.

FIG. 11 is a cross-sectional side view of an illustrative shear force sensor with parallel capacitive electrodes with a variable overlap and with parallel capacitive electrodes with a variable separation distance in accordance with an embodiment.

FIG. 12 is a cross-sectional side view of an illustrative force sensor that uses a housing electrode to make shear force measurements in accordance with an embodiment.

FIG. 13 is a cross-sectional side view of another illustrative force sensor that uses a housing electrode to make shear force measurements in accordance with an embodiment.

FIG. 14 is a cross-sectional side view of an illustrative electronic device having shear force sensor electrodes mounted on a display and an internal support structure in accordance with an embodiment.

FIG. 15 is a cross-sectional side view of an illustrative electronic device having shear force sensor electrodes formed from structures such as display and touch sensor structures in accordance with an embodiment.

FIG. 16 is a perspective view of an illustrative pair of earbuds with a controller of the type that may include force sensors in accordance with an embodiment.

FIG. 17 is a cross-sectional side view of the controller of FIG. 16 in accordance with an embodiment.

FIG. 18 is a perspective view of an illustrative input device with a shaft including shear force sensors in accordance with an embodiment.

FIG. 19 is a perspective view of an illustrative keyboard having keys with shear force sensors in accordance with an embodiment.

FIG. 20 is a perspective view of a cylindrical structure with shear force sensors in accordance with an embodiment.

### DETAILED DESCRIPTION

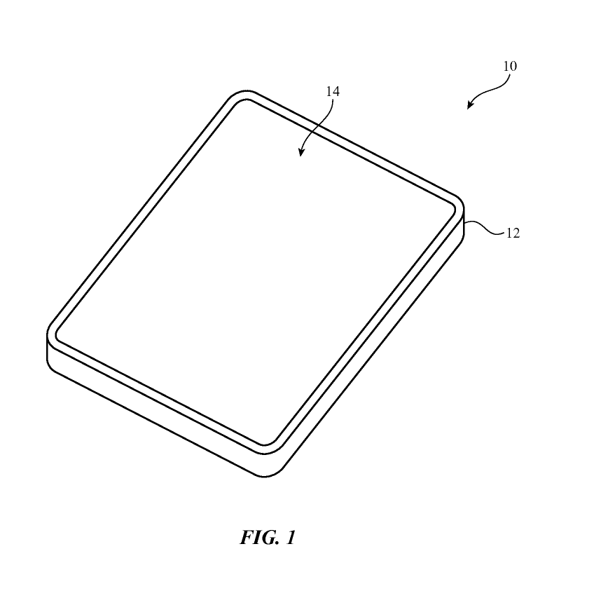

An illustrative electronic device of the type that may be provided with shear force sensing capabilities is shown in FIG. 1. Electronic device 10 may be a computing device such as a laptop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment. In the illustrative configuration of FIG. 1, device 10 is a portable device such as a cellular telephone, media player, tablet computer, wrist device, or other portable computing device. Other configurations may be used for device 10 if desired. The example of FIG. 1 is merely illustrative.

In the example of FIG. 1, device 10 includes a display such as display 14 mounted in housing 12. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.).

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures. A touch sensor may be formed using electrodes or other structures on a display layer that contains a pixel array or on a separate touch panel layer that is attached to the pixel array (e.g., using adhesive).

Display 14 may include an array of pixels formed from liquid crystal display (LCD) components, an array of electrophoretic pixels, an array of plasma pixels, an array of organic light-emitting diode pixels or other light-emitting diodes, an array of electrowetting pixels, or pixels based on other display technologies.

Display 14 may be protected using a display cover layer such as a layer of transparent glass or clear plastic. Openings may be formed in the display cover layer. For example, an opening may be formed in the display cover layer to accommodate a button, a speaker port, or other component. Openings may be formed in housing 12 to form communications ports (e.g., an audio jack port, a digital data port, etc.), to form openings for buttons, etc.

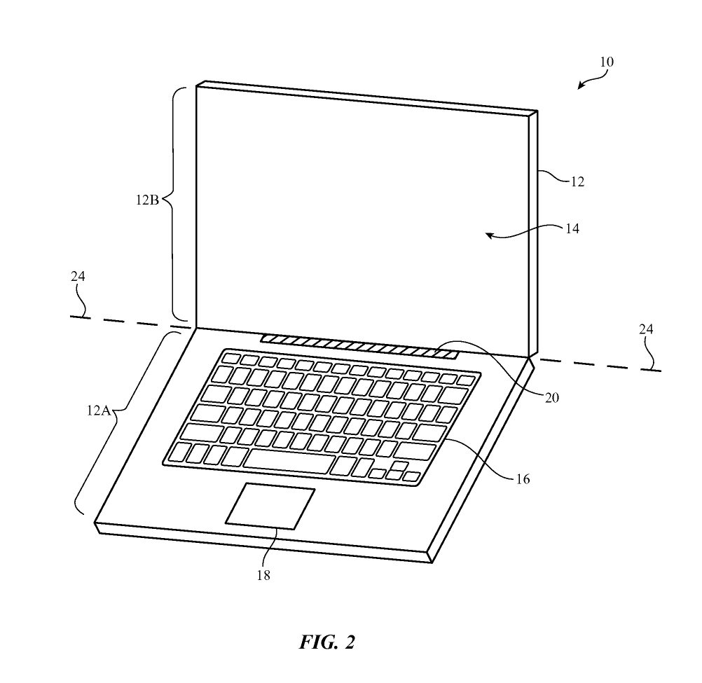

FIG. 2 shows how electronic device 10 may have the shape of a laptop computer having upper housing 12A and lower housing 12B with components such as keyboard 16 and trackpad 18. Trackpad 18 may contain a two-dimensional capacitive touch sensor that measures the location and movement of a user's fingers. Device 10 may have hinge structures 20 that allow upper housing 12A to rotate in directions 22 about rotational axis 24 relative to lower housing 12B. Display 14 may be mounted in upper housing 12A. Upper housing 12A, which may sometimes referred to as a display housing or lid, may be placed in a closed position by rotating upper housing 12A towards lower housing 12B about rotational axis 24.

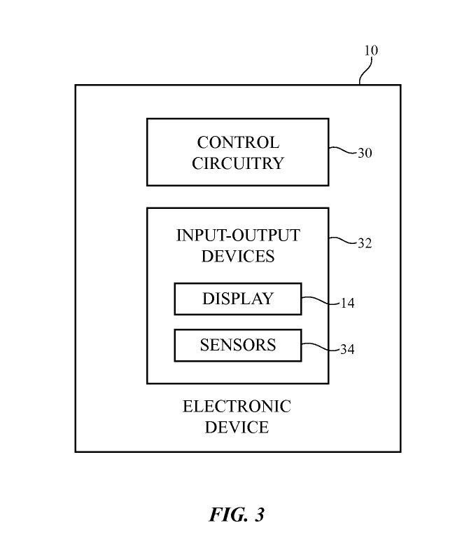

FIG. 3 is a schematic diagram of device 10. As shown in FIG. 3, electronic device 10 may have control circuitry 30. Control circuitry 30 may include storage and processing circuitry for supporting the operation of device 10. The storage and processing circuitry may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in control circuitry 30 may be used to control the operation of device 10. The processing circuitry may be based on one or more microprocessors, microcontrollers, digital signal processors, baseband processors, power management units, audio chips, application specific integrated circuits, etc.

Input-output circuitry in device 10 such as input-output devices 32 may be used to allow data to be supplied to device 10 and to allow data to be provided from device 10 to external devices and users of device 10. Input-output devices 32 may include display 14, buttons, joysticks, scrolling wheels, touch pads, key pads, keyboards, audio components such as microphones and speakers, tone generators, vibrators, cameras, sensors 34, light-emitting diodes and other status indicators, data ports, etc. Wireless circuitry in devices 32 may be used to transmit and receive radio-frequency wireless signals. The wireless circuitry may include antennas and radio-frequency transmitters and receivers operating in wireless local area network bands, cellular telephone bands, and other wireless communications bands.

Sensors 34 may include sensors such as ambient light sensors, capacitive proximity sensors, light-based proximity sensors, magnetic sensors, accelerometers, force sensors, touch sensors, temperature sensors, pressure sensors, compass sensors, microphones, image sensors, and other sensors. Force sensors may be used to detect normal stresses and shear stresses. Force sensing arrangements that detect shear stresses in device 10 may sometimes be referred to as shear force sensors. Shear force sensors may detect shearing motion between electrodes or other structures in the force sensor and/or may detect normal stresses that are associated with shearing stress on device housing structures, portions of display 14, portions of trackpad 18 (FIG. 2), or other device structures. For example, a shear force sensor may detect when a user is laterally shifting a planar track pad surface, a planar display surface, or a region of a planar housing structure in housing 12 in a direction that lies within the planar surface.

Shear force sensors may be based on piezoelectric structures that generate output signals in response to applied force, light-based structures, structures that change resistance based on applied force, or that produce other measureable results based on applied force. With one suitable arrangement, force sensors for device 10 such as shear force sensors may be formed using capacitive sensor electrodes. Control circuitry 30 may detect changes in capacitance associated with the electrodes as stresses are generated that move the electrodes relative to each other. The use of capacitive force sensing technology to measure shear forces on device 10 is, however, merely illustrative. In general, sensors 34 may include force sensors based on any suitable force sensing technology.

Control circuitry 30 may be used to run software on device 10 such as operating system code and applications. During operation of device 10, the software running on control circuitry 30 may gather shear force input from a user, may gather force input in a direction that is normal to the surface of device 10, and may gather other sensor input. Control circuitry 30 can process this input and can take suitable actions (e.g., by adjusting images on display 14, by adjusting audio output or other output from device 10, etc.). The software of device 10 may be used in controlling wireless transmission and reception of communications signals, sensor data gathering and processing operations, input-output device operation, and other device operations.

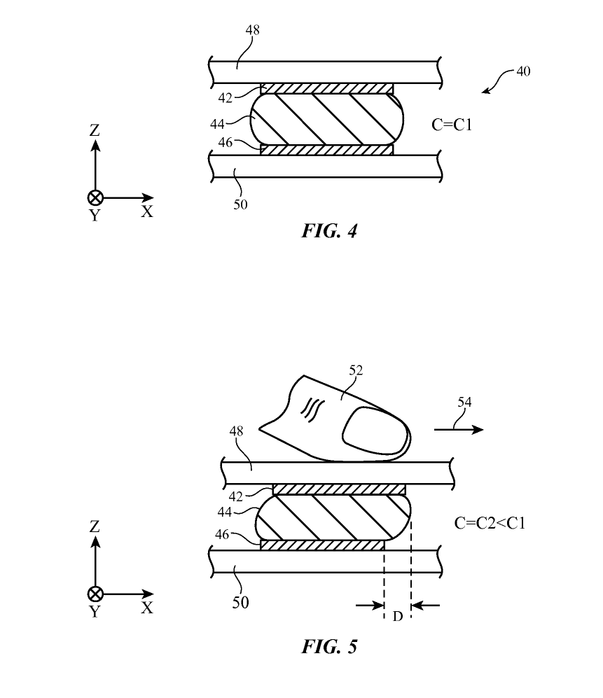

A cross-sectional side view of an illustrative capacitive force sensor of the type that may be used in gathering shear force input is shown in FIG. 4. Force sensor 40 of FIG. 4 has a pair of capacitive electrodes. Upper electrode 42 is separated from lower electrode 46 by dielectric layer 44. Dielectric layer 44 may be a deformable dielectric material such as an elastomeric polymer (e.g., silicone or other elastomer), polymer foam, or other material that can flex or otherwise deform in response to applied force. Force sensor 40 may be coupled between housing structures or other structures in device 10 that move in response to application of shear force.

In the example of FIG. 4, sensor 40 is coupled between upper structure 48 and lower structure 50. Adhesive or other attachment mechanisms may be used to attach electrode 44 to structure 48 and to attach electrode 46 to structure 50 and/or electrodes such as electrodes 42 and 46 may be patterned on the surfaces of layers 48 and 50, respectively (as examples). Structures such as structures 48 and 50 may be planar structures such as a display cover layer or other portion of display 14, a planar structural portion of device 10 such as a midplate member or planar housing wall, may be planar structures such as a planar member that forms the surface of a trackpad (see, e.g., trackpad 18 of FIG. 2), or may be other structures in device 10.

When a user pushes on one or both of structures 48 and 50 with the user's fingers or other external object, the relative positions of these structures may change. For example, when a user places a shear force on structure 48 with respect to structure 50, electrodes 42 and 46 can shift position. The shear force is a lateral force that tends to shift the positions of structures 48 and 50 laterally in a direction that lies in the X-Y plane of FIG. 4 (e.g., within a plane that lies parallel to the planes of structures 48 and 50 in the FIG. 4 example). As shown in FIG. 5, for example, if a user's finger (finger 52) pushes on the upper surface of structure 48 in direction 54, upper electrode 42 will shift relative to the right with respect to lower electrode 46 (which remains stationary on structure 50 in this example). As a result, there will be a portion of electrode 42 (in region D of FIG. 5) that no longer overlaps electrode 46.

During operation of sensor 40, control circuitry 30 (FIG. 3) can make capacitance measurements on sensor 40. In the initial configuration of FIG. 4, electrodes 42 and 46 are aligned with each other, so the area over which electrodes 42 and 46 overlap is maximized. In the configuration of FIG. 5, overlap has been reduced in region D due to the lateral movement of structure 48 and electrode 42 with respect to structure 50 and electrode 46. Because there is less overlap between electrodes 42 and 46, the capacitance measured by control circuitry 30 between electrodes 42 and 46 will decrease by a corresponding amount. By making measurements of the capacitance between electrodes 42 and 46, the amount of shear force imparted to structure 48 in direction 54 can be determined. Control circuitry 30 can then take appropriate action based on the measured shear force. As an example, shear force may be used as input that controls the operation of device 10 (e.g., shear force input may be used to control a game, may be used to move a cursor, may be used to navigate between different on-screen menu operations, or may be used to control other functions in device 10).

If desired, shear forces in device 10 may be measured using force sensors that are sensitive to force applied normal to a capacitor electrode plane. If, for example, first and second parallel capacitor electrodes are separated by a compressible dielectric (e.g., silicone), force applied normal to the plane of the first capacitor electrode will cause the dielectric to compress and the separation between the first and second capacitor electrode to shrink, producing a measurable rise in capacitance. Capacitive force sensors such as these may sometimes be said to contain capacitive normal force sensoing elements.

In general, any type of force sensors such as illustrative force sensor 40 of FIGS. 4 and 5 that produce an output due to shifting motion between capacitor electrodes and/or normal force capacitive force sensors (or other force sensors that detect normal and shear stresses) may be used in measuring applied forces in device 10.

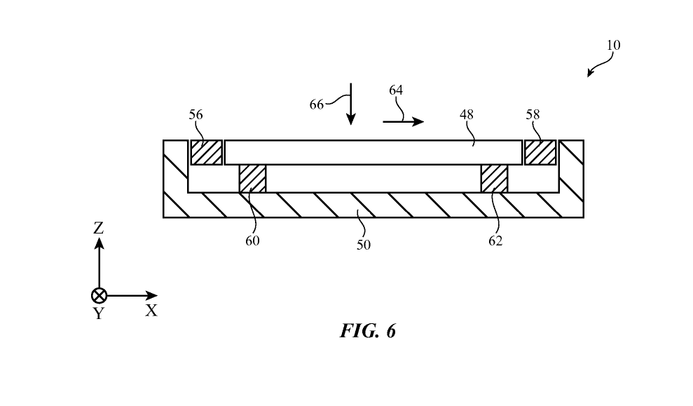

Consider, as an example, the cross-sectional side view of device 10 that is shown in FIG. 6. In the example of FIG. 6, force sensors 56, 58, 60, and 62 have been mounted between structures 48 and 50. Structures 48 and 50 may be planar structures or may have other suitable shapes. Structures 50 may be a portion of housing 12, an internal mounting structure in device 10, or other suitable structure. Structure 48 may be a planar trackpad member (e.g., a plate of glass, metal, plastic, and/or other materials on which an optional two dimensional capacitive touch sensor has been formed), a display cover layer (e.g., a layer of glass, plastic, or other layer in display 14), a touch sensor layer, a housing structure (e.g., a portion of housing 12), or other suitable structures in device 10. There are four force sensors in the example of FIG. 6, but in general, device 10 may have any suitable number of force sensors (e.g., one or more, two or more, three or more, two to ten, more than ten, fewer than ten, etc.).

Force sensors 56, 58, 60, and 62 may include capacitive force sensing elements based on capacitive electrodes. These force sensors may make capacitance measurements to determine the amount of normal force and/or shear force that is being imparted to the surface of device 10. During these measurements, lateral shifts between capacitive force sensing electrodes may be measured (i.e., capacitive force sensing elements for the force sensors may be capacitive shear force sensing elements such as the force sensing element of sensor 40 of FIGS. 4 and 5) or changes in the separation between capacitive force sensing electrodes that take place in a direction normal to the capacitive electrodes may be measured (i.e., capacitive force sensing elements for the force sensors may be capacitive normal force sensing elements formed from a pair of parallel planar capacitive electrodes separated by a compressible dielectric layer).

In device 10 of FIG. 6, for example, sensors 56 and 58 may be based on capacitive normal force sensing elements (or other normal force sensing elements) that are compressed or elongated when structure 48 shifts position within the X-Y plane (i.e., when structures 48 experiences shearing movement relative to structure 50). In this configuration, sensors 56 and 58 may be used to detect shear force on structure 48 in direction 64 (e.g., shearing force on structure 48 may be converted to compressive force on the elastomeric material of the sensing element in sensor 58). If sensors 60 and 62 include capacitive shear force sensing elements (or other shear force sensing elements), these sensors may serve to measure shear force in direction 64.

In illustrative arrangements in which sensors 56 and 58 include capacitive shear force sensing elements, these elements can be configured to measure force in direction 66 (which is normal to structure 48 but which produces shear stress in the sensors). Likewise, sensors 60 and 62 may contain capacitive normal force sensing elements that detect force in direction 66 (i.e., shear force on structure 48 that compresses the normal force sensing elements of sensors 60 and 62). Combinations of these sensors may be used to detect both normal forces and shear forces, if desired.

As these examples demonstrate, shear force sensing elements may be used to measure normal forces or shear forces, depending on the location and orientation in which the shear force sensing elements are installed in device 10 and normal force sensing elements may likewise be used to measure either normal forces or shear forces depending on how they are installed. In general, any suitable combinations of normal and shear force sensing elements may be used in device 10 to measure normal and/or shear forces.

With one suitable arrangement, normal force measurements can be used to detect when a user has pressed on a trackpad, display, or other structure such as planar structure 48 in device 10 and shear force measurements can be used to detect when a user is shifting structure 48 in a direction that lies within a plane containing structure 48. Other configurations may be used for the sensors of device 10 if desired.

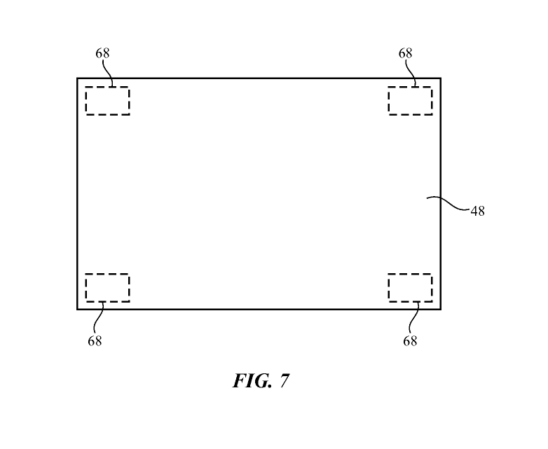

FIG. 7 is a top view of an illustrative planar rectangular structure in device 10 (structure 48) such as a trackpad surface, housing wall, display, or other structure that has been provided with four force sensors (normal and/or shear stress sensing sensors) at each of four corners. If desired, fewer force sensors (e.g., one, two, or three sensors) or more than four sensors may be associated with measuring normal and/or shear forces applied to structure 48. The arrangement of FIG. 7 is illustrative.

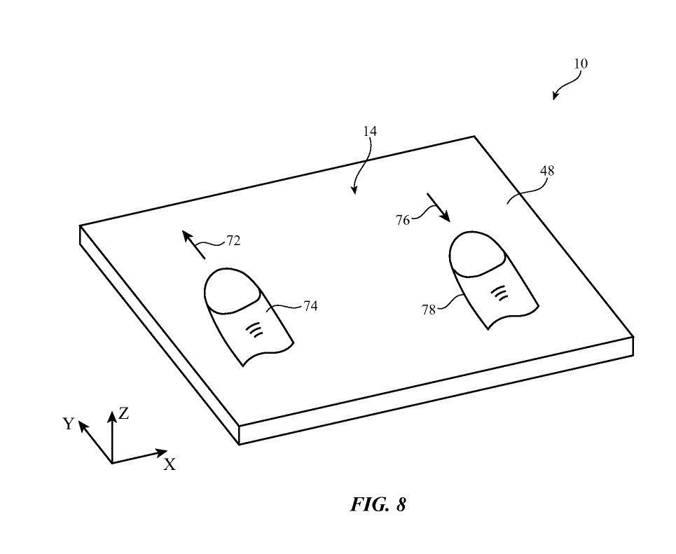

An illustrative shear force input scenario for device 10 is shown in FIG. 8. In the example of FIG. 8, a user is supplying input to the surface of device 10 by shear force to structure 48 in direction 72 from left finger 74 and direction 76 from right finger 78. In this scenario, the user's fingers do not move appreciably across the surface of structure 48, but rather are held in place due to friction. In the FIG. 8 example, the user is attempting to rotate structure 48 about its central vertical (Z) axis, while structure 48 is held in place in the X-Y plane by the structures to which it is mounted in device 10 (e.g., structure 50, etc.). This type of shear force input may be used to steer an object to the right in a game, may be used to rotate an image clockwise in an image manipulation application, or may be used as input to other software operating on device 10 (i.e., control input for control circuitry 30 of FIG. 3). The direction of shear force input provided by the user may vary as the user interacts with the content being displayed on display 14 (e.g., in a configuration in which structure 48 is part of display 14).

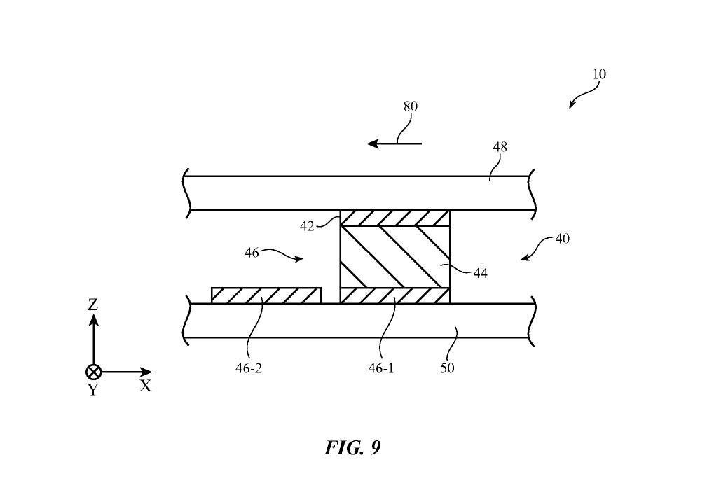

If desired, electrodes for the force sensors in device 10 may be split into two or more parts and/or conductive housing structures or other conductive structures in device 10 may be used as capacitive force sensor electrode structures. As shown in the cross-sectional side view of FIG. 9, for example, lower electrode 46 may be divided into multiple portions such as first electrode 46-1 and second electrode 46-2. As shear force is applied to structure 48 in direction 80, the amount of overlap between electrode 42 and electrode 46-1 will decrease and the amount of overlap between electrode 42 and electrode 46-2 will increase. The signal associated with the increase in capacitance between electrode 42 and electrode 46-2 may be used to supplement the signal associated with the decrease in capacitance between electrode 42 and electrode 46-1 (or may be processed by control circuitry 30 instead of the decreasing signal between electrode 42 and electrode 46-1) to help increase the accuracy of the shear force measurements of sensor 40.

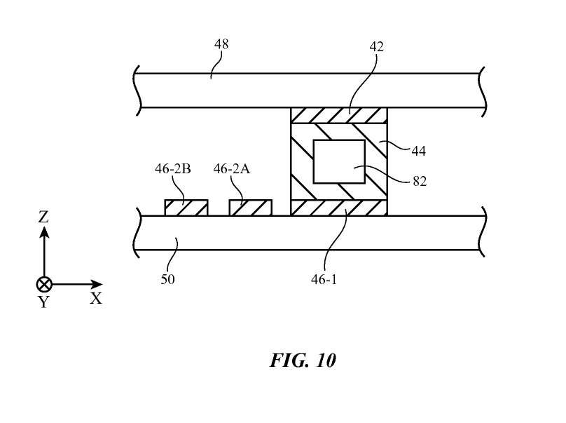

In the example of FIG. 10, supplemental electrode 46-2 has been divided into separate supplemental electrodes 46-2A and 46-2B to provide granularity to the shear force capacitance measurements of sensor 40, thereby enhancing sensor accuracy. The FIG. 10 example also shows how one or more portions of dielectric 44 such as the portion in central opening 82 may be removed to enhance the flexibility of dielectric 44 (e.g., to enhance the ability of the silicone or other material forming dielectric 44 to deform and allow electrode 42 to shift position in the X-Y plane when shear force is applied to structure 48).

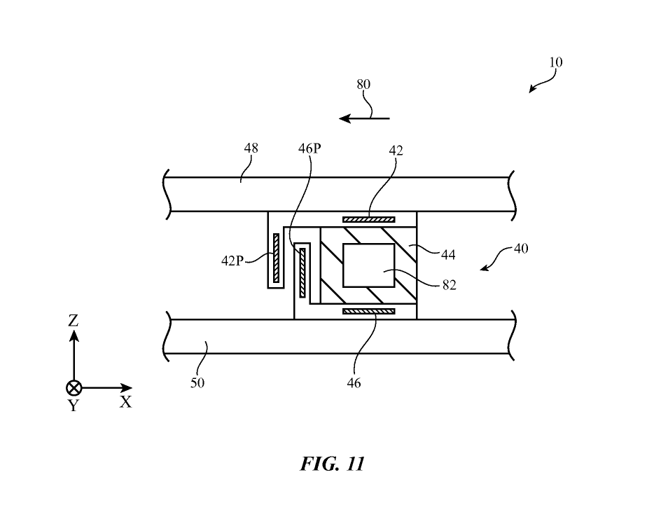

FIG. 11 shows how at least some of the electrodes in a capacitive shear force sensing element for sensor 40 may be arranged to be parallel to each other in a configuration in which the distance separating the parallel electrodes varies as a function of applied shear force. As shown in FIG. 11, sensor 40 may have parallel electrodes 42 and 46 that shift with respect to each other parallel to the X-Y plane of FIG. 11 when shear force is applied to structure 48 in direction 80, as described in connection with sensor 40 of FIGS. 4 and 5. Sensor 40 may also have parallel electrodes 42P and 46P that move in a direction that is normal to the plane of electrodes 42P and 46P (i.e., in a direction along the X axis in the example of FIG. 11) when shear force is applied to structure 48. The change in capacitance produced between electrodes 42P and 46P in response to the application of shear force to structure 48 in direction 80 and the resulting change in separation distance between electrodes 42P and 46P may be greater than the change in capacitance produced between electrodes 42 and 46. The presence of electrodes such as electrodes 42P and 46P may therefore enhance accuracy in sensor 40 when measuring shear forces.

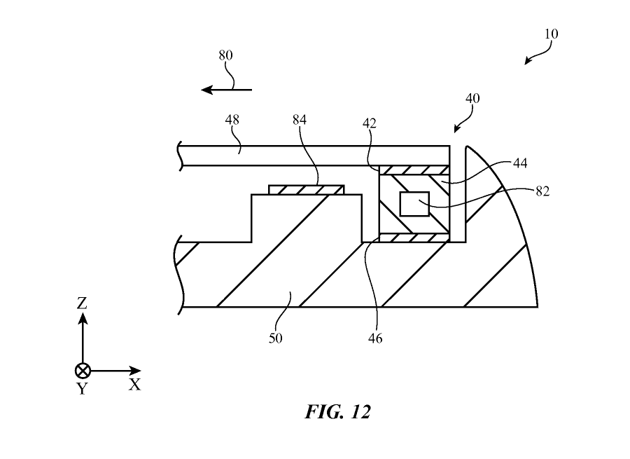

In the illustrative example of FIG. 12, shear force sensor 40 includes electrodes 42, 46, and 84. The capacitance between electrodes 42 and 46 may be monitored to measure the lateral shift in position between electrode 42 and electrode 46 in direction 80 as shear force is applied to structure 48 in direction 80 (or can be used to measure normal force). Electrode 84 may be mounted on structure 50 adjacent to electrode 42. When force is applied in direction 80, electrode 42 will shift laterally in position in the X-Y plane towards electrode 84, so the capacitance between electrode 42 and electrode 84 will rise. Control circuitry 30 may monitor the capacitance between electrodes 42 and 80 to help measure shear forces applied to structure 48 in direction 80. Structure 48 may be part of a track pad, display cover layer or other display layer, part of a housing structure, or other structure in device 10. Structure 50 may be part of a device housing (e.g., housing 12 of FIGS. 1 and 2, etc.), a structure coupled to device housing 12, or other structure in device 10.

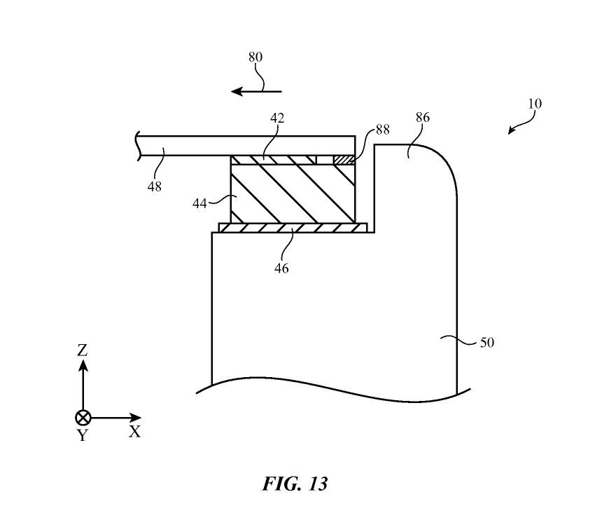

FIG. 13 is a cross-sectional side view of a portion of device 10 in an illustrative configuration in which a conductive structure in device 10 such as structure 50 (e.g., metal in housing 12 or a metal member coupled to housing 12) serves as a capacitor electrode. Sensor 40 may include electrodes 42 and 46 (e.g., to measure force normal to electrodes 42 and 46 in the Z dimension of FIG. 13). Sensor 40 may also include an electrode formed from metal portion 86 of structure 50 and electrode 88. The capacitance between electrode 88 and the electrode formed from portion 86 may change as structure 48 shifts position within the X-Y plane. For example, this capacitance may drop as structure 48 is shifted by application of shear force to structure 48 in direction 80.

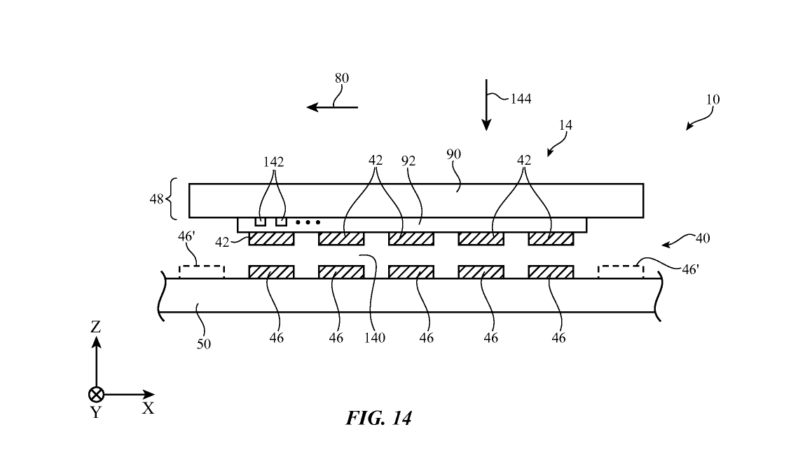

In the illustrative configuration of FIG. 14, device 10 includes display 14. Display 14 may include a planar structure such as structure 48 that is formed from display cover layer 90 (e.g., a transparent layer of glass, plastic, sapphire or other crystalline material, etc.) and other display layers 92. Display layers 92 may be formed from an organic light-emitting diode display, a liquid crystal display, or other display module structures. An array of capacitive touch sensor electrodes may be included in display layers 92. Support 50 may be formed from a portion of housing 12 or other structures in device 10. An air gap such as gap 140 may be interposed between one or more electrodes 42 on the inner surface of structure 48 and one or more opposing electrodes 46 on the outermost surface of support 50. Control circuitry 30 may measure the capacitances between electrodes 42 and electrodes 46 (e.g., in sequence) to determine the amount of overlap between electrodes 42 and electrodes 46. When shear force is applied to structure 48 (i.e., to display 14) in direction 80, the overlap between each of electrodes 42 and its corresponding electrode 46 will decrease in proportion to the amount of applied shear force. If desired, additional electrodes such as electrodes 46′ may be mounted in positions that are laterally adjacent to electrodes 42 and/or 46 to provide additional capacitance measurements responsive to applied shear force. Electrodes 42 and 46 may, if desired, be arranged so as to minimize overlap with the structures of pixels 142 in display 14 (i.e., in structure 48) or pixel structures, touch sensor structures, or other structures associated with a touch sensor in structure 48 and/or display structures in layer 92 may be used in forming electrodes 42 (or 46).

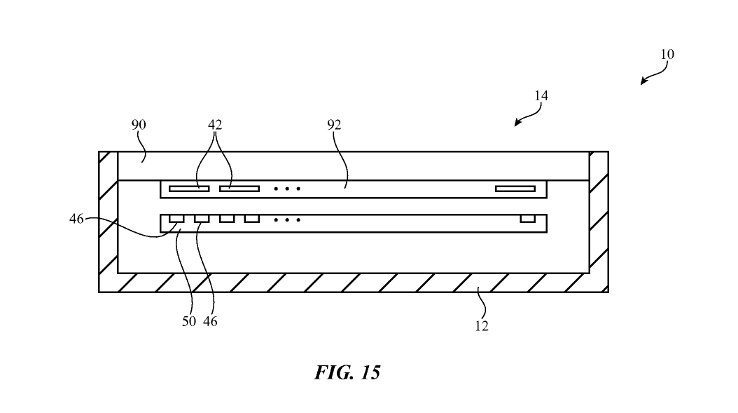

If desired, sensor 40 of FIG. 14 may also be used to gather normal force data. For example, control circuitry 30 may be used to measure capacitance changes between each pair of electrodes 42 and 46 as a user applies force to layer 90 in normal direction 14 (i.e., a direction parallel to axis Z, which is normal to the X-Y plane containing display 14 and the other layers of device 10). Capacitance changes in the pairs of electrodes of sensor 40 can be measured simultaneously or each pair of capacitor electrodes can be monitored in sequence (as examples). As shown in FIG. 15, electrodes 42 may be embedded within layer 92 (e.g., to form separate embedded electrodes or to form electrodes that are shared with display structures such as display pixel structures and/or touch sensor structures).

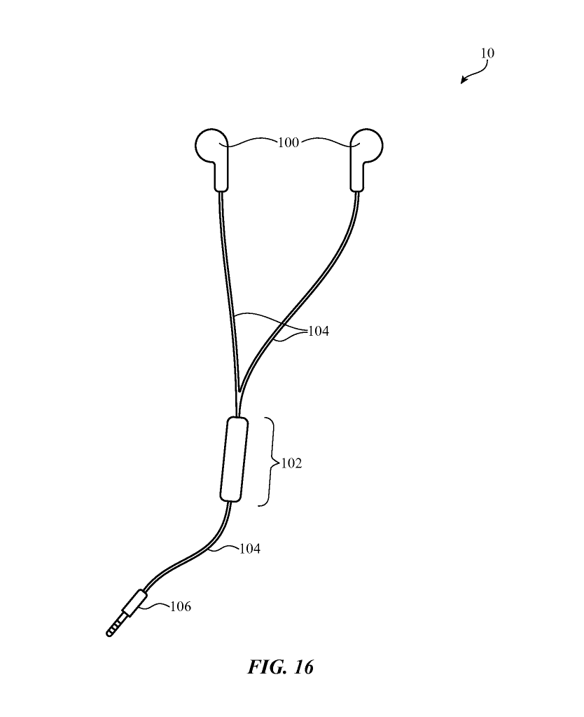

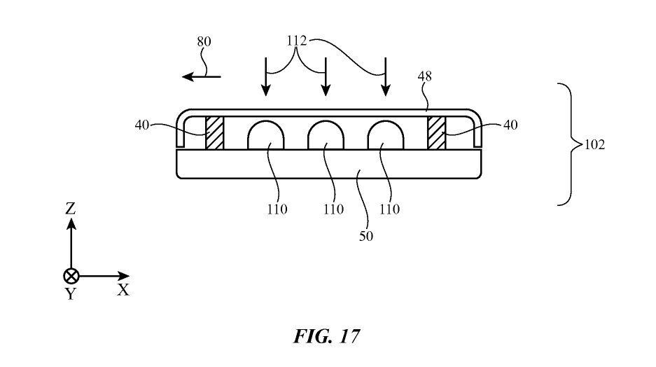

In the example of FIG. 16, device 10 is a headset and has a pair of earbuds 100 coupled to audio jack 106 by cable 104. Device 10 of FIG. 16 has a user input component such as controller 102. As shown in FIG. 17, controller 102 may have a deformable housing (structure 48). Shear force sensors 40 or other force sensors and, if desired, optional components such as dome switches 110 may be mounted under structure 48. This arrangement may allow a user to activate one or more dome switches 110 within controller 102 by pressing in directions 112. Shear force sensors 40 may be coupled between structures 48 and 50. Shear force sensors 40 may be used to detect shear force applied to structure 48 in the X-Y plane, such as force applied in direction 80, which may shift structure 48 relative to structure 50. Capacitive normal force sensing elements may also be used in controller 102.

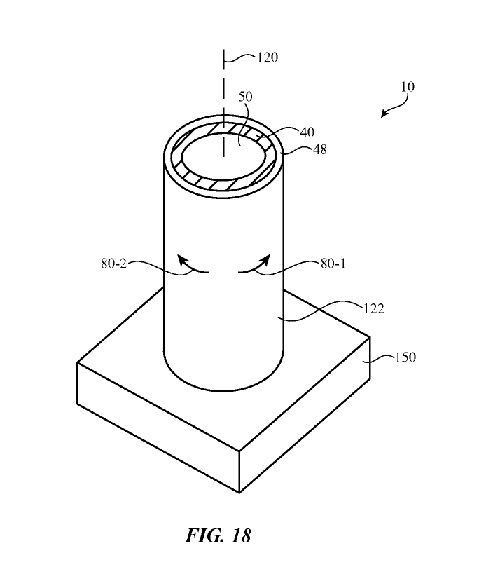

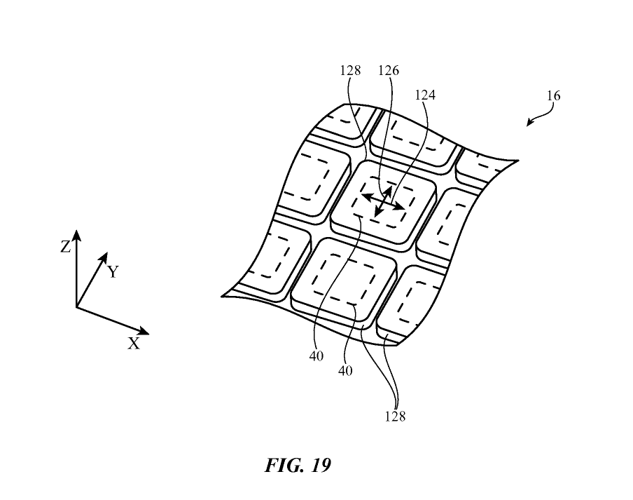

If desired, rotational motion may be detected using shear sensors. Consider, as an example, joystick device 10 of FIG. 18. Shaft 122 of device 10 may be mounted to base 150 and may extend along longitudinal axis 120. Inner shaft structure 50 may be attached to base 150. A user may grip the outer surface of shaft 122 and may twist outer structure 48 of shaft 122 about axis 120 relative to inner structure 50. Shear force sensor 40 is mounted between structure 48 and structure 50, so that movement of structure 48 in direction 80-1 or direction 80-2 as the user twists shaft 122 about axis 120 will result in capacitance changes at the output of sensor 40.

Shear force sensors may also be used in a keyboard or other button-based interface (e.g., to provide an input mechanism for gathering cursor positioning input or other user input). In the example of FIG. 19, keyboard 16 contains an array of keys 128. One or more of keys 128 may each be provided with one or more shear sensors, as illustrated by sensors 40 of FIG. 19. As a user applies shear force to the upper surface of keys 128, the keys may shift laterally within the X-Y plane in directions such as directions 124 and/or 126. Control circuitry 30 may use sensors 40 to detect this shearing motion and may take appropriate action in response.

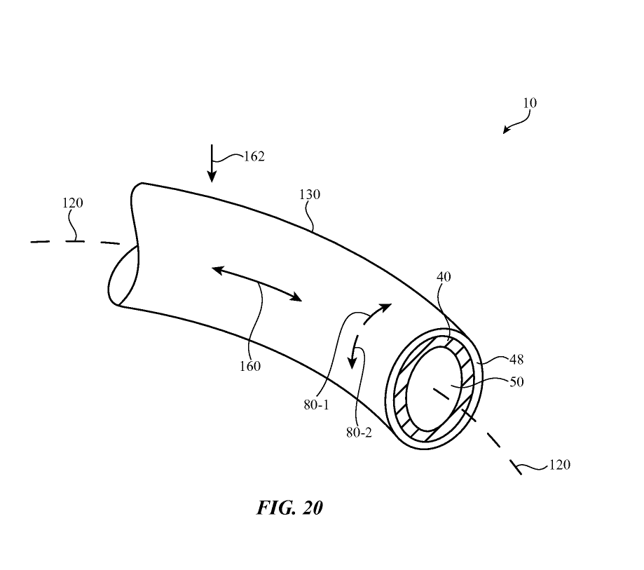

FIG. 20 is a perspective view of an illustrative electronic device 10 that has a cylindrical shape. The cylindrical shape of device 10 may be straight or may be curved (e.g., device 10 of FIG. 20 may be used in forming a cylindrical ring structure such as part of a wheelchair wheel, vehicle steering wheel, a joystick with a bent cylindrical shape, or other ring-shaped or elongated structure). A user may twist outer structure 48 relative to inner structure 50 about axis 120 in directions such as directions 80-1 and 80-2. Shear sensor 40 may be coupled between structures 48 and 50 to measure this twisting (shearing) motion and thereby supply appropriate output to control circuitry 30. If desired, shear sensors 40 may be configured to detect shearing movements along directions 160 (e.g., parallel to line 120, which runs through the core of structure 50 in the example of FIG. 20). Force sensors may also be used to detect inward compression of structure 130 in direction 162 (e.g., when a user squeezes structure 130).

Structures 48 and 50 in device 10 may be formed from soft materials such as fabric, from transparent materials such as clear glass, plastic, or sapphire, from materials such as metal, ceramic, carbon-fiber materials or other fiber composites, wood or other natural material, and/or other materials. If desired, some or all of the capacitive electrodes in force sensors 40 may be formed from metal traces on these substrates, stamped metal foil, machined metal members, wires, or other conductive structures.

The foregoing is merely illustrative and various modifications can be made by those skilled in the art without departing from the scope and spirit of the described embodiments. The foregoing embodiments may be implemented individually or in any combination.

What is claimed is:

1. An electronic device, comprising:
a first structure;
a second structure;
a shear force sensor coupled between the first and second structures; and
control circuitry that uses the shear force sensor to measure shear force applied to the first structure relative to the second structure.

2. The electronic device defined in claim 1 further comprising a display, wherein the first structure forms part of the display.

3. The electronic device defined in claim 2 wherein the shear force sensor comprises at least one capacitive electrode coupled to the first structure.

4. The electronic device defined in claim 3 wherein the second structure has a conductive portion and wherein the control circuitry makes measures capacitance between the capacitive electrode and the conductive portion of the second structure.

5. The electronic device defined in claim 1 wherein the shear force sensor comprises first and second planar electrodes that are parallel to each other and wherein the control circuitry measures a capacitance between the first and second planar electrodes.

6. The electronic device defined in claim 5 wherein the first planar electrode shifts position relative to the second planar electrode within a plane that contains the first planar electrode in response to the shear force.

7. The electronic device defined in claim 6 further comprising an elastomeric structure between the first and second planar electrodes that deforms in response to application of the shear force.

8. The electronic device defined in claim 7 further comprising a display, wherein the first structure forms part of the display.

9. The electronic device defined in claim 5 wherein the first planar electrode and the second planar electrode are offset by a distance in a direction normal to a plane containing the first planar electrode and wherein the first planar electrode moves relative to the second planar electrode to change the distance in response to application of the shear force.

10. The electronic device defined in claim 1 wherein the first structure comprises a keyboard key.

11. The electronic device defined in claim 1 further comprising:
a controller;
earbuds; and
a cable coupled between the controller and the earbuds, wherein the controller includes the first structure.

12. The electronic device defined in claim 1 wherein the first structure has a cylindrical surface and wherein the shear force is produced when a user twists the cylindrical surface.

13. An electronic device comprising:
a housing;
a display mounted in the housing;
control circuitry; and
a shear force sensor with which the control circuitry measures shear force applied to the display relative to the housing.

14. The electronic device defined in claim 13 wherein the display lies in a plane, wherein the shear force is applied in a direction that lies within the plane, wherein the shear force sensor comprises a capacitive sensor having at least first and second capacitive electrodes, and wherein the control circuitry measures the shear force by measuring capacitance between the first and second capacitive electrodes.

15. The electronic device defined in claim 14 wherein the first capacitive electrode is coupled to the display.

16. The electronic device defined in claim 15 wherein the shear force sensor comprises a dielectric structure interposed between the first and second capacitive electrodes.

17. The electronic device defined in claim 16 wherein the dielectric structure comprises an elastomeric material that deforms as the first electrode shifts position with respect to the second electrode.

18. The electronic device defined in claim 17 wherein the first and second capacitive electrodes are planar.

19. The electronic device defined in claim 18 wherein the first and second capacitive electrodes lie in planes parallel to the plane in which the display lies.

20. A shear force sensor that detects lateral movement within a plane of a first structure relative to a second structure as a shear force is applied to the first structure, the shear force sensor comprising:
a first planar capacitive electrode;
a second planar capacitive electrode; and
an elastomeric structure coupled to the first planar capacitive electrode and coupled to the second planar capacitive electrode, wherein the elastomeric structure deforms in response to the lateral movement of the first structure within the plane.

21. The shear force sensor defined in claim 20 wherein the first and second planar capacitive electrodes are parallel to each other.

22. The shear force sensor defined in claim 21 wherein the first and second planar capacitive electrodes are characterized by an amount of overlap between the first and second planar capacitive electrodes and wherein the amount of overlap changes in response to the lateral movement of the first structure within the plane.

23. The shear force sensor defined in claim 21 wherein the first and second planar capacitive electrodes are characterized by a separation distance along a direction that is normal to the first and second planar capacitive electrodes and wherein the separation distance changes in response to the lateral movement of the first structure within the plane.
